(19) United States
(12) Patent Application Publication
(10) Pub. No.: US 2002/0156603 A1
(43) Pub. Date: Oct. 24, 2002

(54) Modeling tool with controlled capacity

(76) Inventors: Bernard Alhadef, Castellet (FR); Marie-Annick Giraud, Bandol (FR)

Correspondence Address: Schnader Harrison Segal & Lewis, 1600 Market Street, 36th Floor, Philadelphia, PA, 19103, US

(21) Appl. No.: 09/858,814

(22) Filed: May 16, 2001

Related U.S. Application Data
(63) Continuation of application No. PCT/FR99/02810, filed on Nov. 17, 1998.

(30) Foreign Application Priority Data
Nov. 17, 1998 (FR) 98/14422

(51) Int. Cl. G06F 17/10

(52) U.S. Cl. 703/2

(57) ABSTRACT

The invention concerns a method for modelling digital data from a data sample comprising means for acquiring input data, means for preparing the input data, means for constructing a learning model on the processed data, means for analyzing the resulting model, means for operating the resulting model, characterized in that it consists in controlling by regression the consistency of the standard learning process by adding to the covariance matrix a disturbance in the form of the product of a scalar quantity λ by a matrix H during the model computation.

The invention provides a model for the prediction of the evolution of a phenomenon from a digital data set of any size. It can be implemented in the form of specifically designed integrated circuits and then present itself in the form of a specific element functioning in an independent manner. It can also be implemented in software form and be integrated in a computer program. It can, especially, be used for processing a digital signal in an electronic circuit. In a more general application, it enables the modeling of nonlinear phenomena, the analysis of phenomena by means of immediately exploitable formulas and the generation of robust models. The precision enabled by these novel methods makes it possible to appreciably increase machine learning rates.

The invention can also be used in the domain of risk analysis by insurance companies. These companies store, in a form that is structured to varying degrees, the characteristics of drivers, their vehicles and accidents they have been involved in or caused. It is possible to determine which are at high risk based on these available elements.

In the modeling of physical phenomena, the events analyzed correspond generally to the data collected by the various sensors in the measurement chain. It is possible, for example, to determine which are the combinations of factors that are the source of defective products and thus anticipate the problems and improve productivity.

In the domain of flow management, these events correspond instead to the information collected over time. It is possible, for example, to determine the relations existing among the flows considered and the calendar data, or variables that are more specific to the application under consideration such as meteorological data for the consumption of electricity or promotional periods for sales analysis, which enables better stock management and orders from manufacturing plants.

In the banking sector, the events would represent on the one hand the profile of the clients and on the other hand a descriptor of the operations. The modeling would reveal, for example, the risk factors linked to individuals and to operations.

The problem of machine learning is to find dependencies using a limited number of observations. Thus, it is a question of selecting in a set of given functions f(x, α), αεA, in which A is a set of parameters, that which best enables approaching the outcome.

If L(yf(x, α) is a measure of the deviation between the real outcome and the outcome predicted by the model f(x, α), it is thus necessary to minimize the effective risk:

R(α)=∫L(y,ƒ(x,α))dF(x,y) (1)

While knowing that the distribution of probability F(x, y) is unknown and that the sole available information is contained in the k data (x₁, y₁) . . . , (xₖ, yₖ) from the set of observations (learning data).

Classically, one determines the function that minimizes the empirical risk calculated on the basis of the learning data:

$${R}_{e mp} = \frac{1}{k} {\sum }_{im1}^{k} L ( {y}_{1} , f ( {x}_{1} , α ) ) \qquad ( 2 )$$

One then postulates that which would be the best approximation of the function that minimizes the effective risk given by (1).

The problem posed is to know the extent to which a system constructed on the principle of minimization of the empirical risk (2) is generalizable, i.e., enables minimizing the effective risk (1) including the data that have not been learned.

Mathematically, a problem is said to be correctly posed when it allows a sole solution and this solution is stable, i.e., that a slight modification of the initial conditions can only modify in an infinitesimal manner the form of the solutions. The problems that do not possess these properties are referred to as poorly posed problems.

It occurs frequently that the problem of finding f satisfying the equality Aƒ=u is poorly posed: even if there exists a single solution to this equation, a small variation of the second member can lead to large variations in the solution.

And thus if the second member is not exact (u_{ε} instead of u with |u−u_{ε}|≦ε), the functions that minimize the empirical risk R(ƒ)=|Aƒ−u_{ε}∥² are not necessarily good approximations of the solution that is being sought, even when ε tends toward 0.

An improvement in the search for solutions consists in minimizing another functional, referred to as regularized, of the form:

R(ƒ)=R(ƒ)+λ(ε)Ω(ƒ) (3)

in which:

Ω(ƒ) is a functional belonging to a special type of operator referred to as regularizing;

λ(ε) is a carefully selected constant which is dependent on the noise level existing in the data.

One then obtains a series of solutions which converge towards the good solution when ε tends towards 0. By minimizing the regularized risk rather than the empirical risk, one thereby obtains from a limited number of observations a solution which is generalizable to the set of cases.

Introduction of the regularizing term makes it possible to provide with certainty a single solution to a poorly posed problem This solution can be slightly less accurate than the classic solution, but is possesses the fundamental property of being stable, thus endowing the results with greater robustness. The methods for resolving poorly posed problems show that there exist other inductive principles that enable obtaining a better regularization capacity than the principle consisting of minimizing the error made on the learning set.

Thus, the principal objective of the theoretical analysis is to find the principles making it possible to control the generalization capacity of the learning systems and to construct the algorithms that implement these principles.

Vapnik's theory is the tool that enables finding the necessary and sufficient conditions to be established for a learning process based on the principle of minimization of the empirical error to be generalizable, leading to a new inductive principle referred to as the principle of minimization of the structural risk.

It can be shown that the effective risk verifies an inequality of the form:

R(α)<Rₑₘₚ(α)+F(h,k) (4)

in which:

h is the Vapnik-Chervonenkis dimension of the space of functions f(x, α) among which the solution is sought;

k is the number of observations available for constructing the model;

F is an increasing function of h and a decreasing function of k.

It can be seen immediately that, since the number k of the available observations is finite, the fact of minimizing the empirical error is not sufficient for minimizing the effective error. The general idea of the principle of minimization of the structural risk is to take into account the two terms of the second member of (4), rather than solely the empirical risk. This implies constraining the structure of the set of the functions f(x, α) among which the solution is sought so as to limit or even control the parameter h.

According to this principle, the development of new algorithms enabling control of the robustness of the learning systems can be envisaged.

The invention pertains to a new modeling technology of very general application, the essential characteristics of which concern the efficacy of the method, the simplicity of the models obtains, their robustness, i.e., their performance on data that have not been used for learning. The installation of this technique in an electronic or mechanical information-processing system equipped with sensors and model exploitation functions enables conception of a tool capable of adapting to and controlling an environment in which there exist complex and changing phenomena, and in which the sensors only partially take into account the set of the phenomena brought into play. Furthermore, the extreme simplicity of the models obtained provides the user of the tool with an intuitive comprehension of the phenomena he seeks to control.

The invention uses both the classic techniques, such as calculation of the covariance matrices, as well as more recent theories, such as those of statistical regularization and the consistency of the learning processes. The invention is comprised in that the covariance matrices are not used as such but according to a new process which consists on the one hand of perturbing the covariance matrix in a certain manner and on the other hand of adjusting the level of added noise in another manner. The manner in which one adds and controls noise to the data will be described here in a mathematical manner but it is possible to implement these operations in an electronic or mechanical manner.

The invention is comprised of a process for modeling digital data from a data sample, comprising means for acquiring the input data, means for preparing the input data, means for constructing a model by learning on the data processed, means for analyzing the performances of the model obtained, means for exploiting the model obtained, characterized in that one controls the consistency of the classic machine learning regression process by the addition to the covariance of a perturbation in the form of a matrix H dependent on a vector of k parameters Λ=(λ₁, λ₂, . . . λₖ) or in the form of the product of a scalar λ times a matrix H, during the calculation of the model. The matrix H can be such that H(p+1, p+1) is different from at least one of the terms H(i, i) for i comprised between 1 and p.

Subsequently, two numbers are considered to be close when their relative deviation does not exceed 10%.

The matrix H advantageously verifies the following conditions: H(i, i) is close to 1 for i comprised between 1 and p, H(p+1, p+1) is close to 0 and H(i, j) is close to 0 for i different from j. In a variant, the matrix H verifies the following conditions: H(i, i) is close to a variable a for i comprised between 1 and p, H(p+1, p+1) is close to a variable b, H(i, j) is close to a variable c for i different from j with a=b+c.

In an advantageous variant, the matrix H verifies the following supplementary conditions: a is close to 1−1/p, b is close to 1, c is close to −1/p, in which p is the number of variables of the model.

Preferentially, one adds an automatic adjustment module for the parameter λ which can be such that the parameter λ adjustment module is implemented by the integration of a module for the separation of the learning data into two preferably disjoint subsets: one subset serving as learning base for the modeling process and the other subset serving for adjusting the value of the parameter λ according to a model validity criterion obtained on the data that did not participate in the learning. The adjustment module can also be used to adjust the vector of parameters Λ. In both cases, this module can be the object of automation, either by acting directly on the parameter(s), or by means of a coding function (exponential, logarithm or others).

The base data separation module can be implemented by an external software program of the spreadsheet or database type and can perform a purely random sort into two subsets or a random sort into two subsets, while respecting the representativeness of the input vectors in the two subsets.

The data are advantageously prepared by statistical normalization of the columns of data, by reconstitution of the missing data or by detection and possible correction of the aberrant values.

This preparation can be implemented by a monovariable or multivariable polynomial development applied to all or part of the input, by a trigonometric development of the input or by an explicative development of the input of date type. A preferential variant consist of using a change of reference point stemming from an analysis in principal components with possible simplification or one or more temporal shifts before or after all or part of the columns containing the temporal variables.

An explorer is advantageously added to the preparations, which is supported on a descriptor of the possible preparations by the user and on an exploration strategy based either on a pure performance criterion in learning or in generalization, or on a compromise between these performances and the capacity of the learning process obtained.

In one variant, one adds to the modeling process an exploitation module generating monovariable or multivariable polynomial formulas descriptive of the phenomenon, trigonometric formulas descriptive of the phenomenon, or descriptive formulas of the phenomenon containing date developments in calendar indicators.

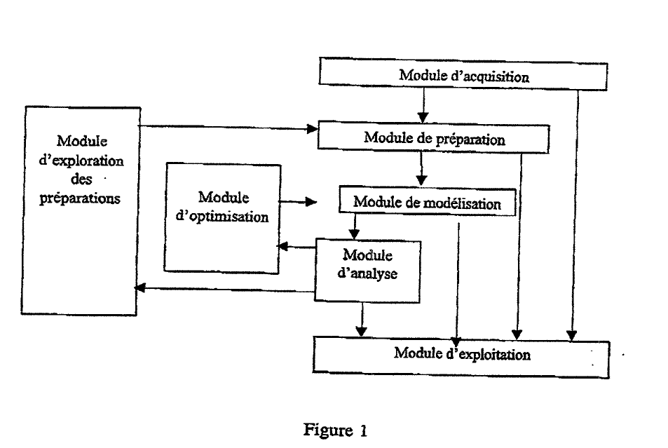

The general synopsis of the invention is presented in FIG. 1. It comprises all or part of the following elements:

a data acquisition module (1);

a data preparation module (2);

a modeling module (3);

a performance analysis module (4);

an optimization module (5);

a preparation exploration module (6);

an exploitation module (7).

The purpose of the data acquisition module (1) is to collect the set of information required for the preparation of the models. The collection is implemented by means of acquisition configuration information, which is transmitted by an operator, either once and for all upon conception of the system, or in a dynamic manner as a function of new requirements identified over the course of its exploitation. The data can be collected by means of sensors of physical measurements, or in databases by means of requests, or both. In configuring the acquisition, the operator defines for the tool a modeling problem to be handled. On demand, this module produces a rough history of the phenomenon, characterized by a table containing in columns the characteristic magnitudes of the phenomena (stemming for example from the sensors) and in rows the events, each of which corresponds to one observation of the phenomenon. This historic table can be supplemented by a descriptor of the data comprising information which can be useful for the modeling, and then for the exploitation of the models. The descriptor typically contains the following information:

name of the column;

reference of the associated sensor;

nature of the data (Boolean indicator, whole, digital, data, region, etc.).

The data preparation module (2), also referred to as the data processing module, enables refinement of the characteristics of the raw data stemming from the acquisition. Based on the historic table and the data descriptor, this module prepares a more complex table in which each column is obtained from a processing operating on one or more columns of the historic table. The processes implemented on a column can be especially:

a transformation of the column by a classic function (log, exp, sin, etc.), with each element of the column being replaced by its image by the selected function;

a polynomial development of monovariable K order, generating K columns from one input column x, corresponding to the variables x, x², . . . , x^{K};

a spectral development of period T and of order N, generating 2K columns from one input column x, the K first columns being equal to cos(2πix/T) (i being comprised between 1 and K), and the K last columns being equal to sin(2πix/T) (i being comprised between 1 and K);

a development in calendar indicators, generating for one input column of date type a list of finer indicators of the events associated with this date (annual trigonometric developments, weekly trigonometric developments, monthly trigonometric developments, Boolean indicators of day of week, holiday, extended weekend, day before extended weekend, day before the day before extended weekend, day after extended weekend, indicators of holiday, of beginning and end of holidays specific to each region, etc.).

The data preparation module can also act on multiple columns or multiple groups of columns. It can especially perform the following constructions:

based on a date column and a region column, the preparator can perform a development of indicators of the meteorological type (wind, precipitation, hygrometry, etc.) for the day itself or adjacent days. This operation is performed from a meteorological database;

based on two groups of columns G1 and G2, the preparator can create a new group of columns G3 comprising the intersecting products between all of the columns of the two groups;

from a group of columns G, comprising p variables x₁, x₂, . . . xₚ, the preparator can generate all of the polynomial terms of degree inferior or equal to K, thus a group of columns each comprising a term of the type (x₁)^{K1}(x₂)^{K2} . . . (xₚ)^{Kp} with (K1+ . . . +Kp)≦K, with all of the Ki being comprised between 0 and K.

The data preparation module can also perform operations on rows, notably:

centering, which subtracts from each element of a column the mean obtained on its column;

reduction, which divides each element of a column by the standard deviation of its column;

statistical normalization which links together the two preceding operations.

The data preparation module can also perform global operations in a manner especially so as to reduce the dimension of the problem:

elimination of a column if its standard deviation is zero;

elimination of a column whose correlation with a preceding column is greater than a threshold;

elimination of a column whose correlation with the output is inferior to a threshold;

performance of a principal component analysis which leads to a change of reference points by favoring the principal axes of representation of the phenomenon, and the possible elimination of the nonsignificant columns.

The data preparation module also enables defining the treatment of missing values. A sample containing one or more missing values will be ignored by default. Nevertheless, the user can replace the missing value according to various criteria:

mean of the value on the column;

mean of the value on a subset of the column;

the most frequent value (Boolean or enumerated);

selection of a fixed replacement value;

estimation of this value based on a modeling as a function of other variables.

Another manner of treating the missing values is to consider them as a particular state of the variable that one can, for example, take into account by creating a Boolean supplementary column indicating whether the value is present or not.

The data preparation module also enables detection and treatment of suspicious values. Detection is based on the following criteria:

data outside of a range defined by the operator;

data outside of a range calculated by the system (for example, range centered on the mean value and large by K times the standard deviation, analysis of the extreme percentiles, etc.);

for Boolean or enumerated data, values whose number of occurrences is inferior to a given threshold.

Sample containing one or more suspicious values can be treated following the same methods as those proposed for missing values.

For temporal variables of type X(t), the preparation module also enable automatic generation of the columns corresponding to the variable X taken at different anterior or posterior instants. Thus, the variable X(t) comes to be replaced by a group of variables: {X(t−kdt), . . . , X(t−dt), X(t), X(t+dt), . . . , X(t+ndt)}.

The data preparation module offers all of these possibilities on a unitary basis but also allows the user to combine these treatments by means of an adapted control language. The set of these data preparation possibilities is also accessible to the preparation exploration module. The preparation process is terminated preferentially by a normalization operation.

The modeling module (3), due to its novel technology, enables treatment of a large number of input columns while controlling the validity and robustness of the model. It is thus perfectly suitable for the preparator of data described above, which is capable of generating a very large number of explicative columns.

The modeling module uses a history of the data after preparation. It can be used on the set of these data, but exhibits all of its performance when it is only used on a part (the rows) of these data, with this part being defined by the optimization module.

The modeling module proceeds in the following manner:

the table of the input data after preparation constitutes a matrix called [X], the column vector of the outputs corresponding to these inputs constitutes a column vector [Y];

one constructs a matrix [Z] from the matrix [X] by completing it to the right by a column of 1;

the model vector [w] is obtained by the following formula:

[w]=(^{t}[Z][Z][Z]+λ[H])⁻¹ (^{t}[Z][Y]) in which [H] is a particular matrix enabling rapid calculations and in which λ is a scalar.

the output y* of the model for an input vector [x]=(x1, . . . , xp) is obtained by adding a constant equal to 1 to the series of the vector [x], so as to thereby obtain the vector [z]=(x1, . . . , xp, 1), then in performing the scalar product between the vector [w] and the vector [z], i.e., y*=w₁x₁+ . . . +wₚxₚ+wₚ₊₁.

The analysis module (4) evaluates the performances of the model in relation to certain criteria, the performances being evaluated either on the basis of the learning history, i.e., on the data used for the calculation of the matrix [X], or on the data that did not participate in the learning (history referred to as “of generalization”). The performances are evaluated by comparing on the designated history the vector [y], corresponding to the real value of the output, with the vector [y*], corresponding to the value of the output obtained by application of the model. The comparison can be performed with the classic statistical error indicators with or without screening.

The analysis module also enables sorting the data of a history either in rows or in columns. The row sort criterion relates to the modeling error. This criterion allows separation of the individuals conforming to the model from the nonconforming individuals. The nonconforming individuals can be due to anomalies found at the level of the sensors, but they can also reveal an abnormal or original behavior, information which can be very value according to the context.

The column sort criterion is implemented as a function of the model vector [w]. This enables arranging in order the factors influencing the phenomenon as a function of their positive or negative contribution to the phenomenon.

The purpose of the optimization module (5) is the adjustment of the parameter k. In order to do this, it separates the history data into two parts, one serving as learning base for the modeling module and the other serving to analyze the performances of the model on the unlearned data. The optimization module automatically activates the modeling module by varying the parameter λ in a manner so as to obtain an optimum of performances on the unlearned data. The construction itself of the model and of the perturbation matrix [H] confer on the scalar λ particular properties, and especially the property of working on the effective capacity of the learning structure.

The optimization criterion can be selected by the operator from among all of the possibilities offered by the analysis module.

The separation of the data can be performed directly by the operator, but it can also be implemented by the system in different manners.

The preparation exploration module (6) constitutes the second level of adjustment of the capacity of the learning structure. This module links together the modelings (with or without optimization of the scalar λ) by changing the preparation of the data at each step. This module uses a descriptor of the possible preparations provided by the user. This descriptor defines in order the columns, the groups of columns and the preparations operating on these columns or groups of columns. For example, the descriptor of the possible preparations can define among the variables of the base history:

a possible polynomial development of column 1, of degree 1 at minimum to degree 5 at maximum;

a possible trigonometric development of column 2 of degree 1 at minimum to 7 at maximum;

a possible multivariable polynomial development on columns 4 to 8 of degree 1 at minimum and 3 at maximum;

all or part of the other columns without specific treatment.

This descriptor enables formalization of the knowledge of the user in relation to the phenomenon to be modeled. The preparation explorer thus relieves the user of the tedious tasks of exploration of the possible preparations by performing the preparation of the data, the modeling, analysis of performances and recording of the references of the trial and the results obtained.

This exploration is performed by means of the parameters left free by the descriptor filled out by the user. The explorer can activate different methods in order to perform this function. Among these methods, the simplest is the systematic exploration of all the possible combinations in the parameters left free by the operator. However, this method can be very costly in terms of calculation time, given that the number of calculations increases exponentially with the number of parameters.

Another method consists of performing random sorts in the possible parameters and then sorting the results in a manner so as to approach the zones of greatest interest.

A third method consists of employing a control of the capacity of the second level learning process. For this, one uses the fact that for each type of development (polynomial, trigonometric, etc.), the capacity of the learning process increases with the parameter (degree of development). The method starts from a minimal preparation (all of the parameters are at their minimum), and then it envisages all of the possible preparations by incrementing a single parameter. On each of the preparations obtained, the method launches a modeling and selects from among the set of models obtained the one which has the best performance according to a certain criterion.

This criterion can be determined on the basis of the objective established by the user:

a minimum of error with or without screening on the unlearned data;

the relation between one of the preceding criteria and the capacity of the learning structure after preparation (it being possible to approach this capacity by means of known formulas);

the relation between the increase in one of the preceding criteria and the increase in the capacity of the learning structure;

an increasing function as a function of an error criterion such as described above, and decreasing as a function of the capacity of the learning structure.

The exploitation module (7) enables the tool to transmit the modeling results to a user or to a host system. In a simple version, it can calculate the output of the model evaluated on the unlearned data by producing indications regarding the reliability of the estimation. In a more developed version, the exploitation module can transmit to a host system the model developed, its preparation and its performances. In an even more developed version, the tool is entirely controllable by the host system, such as an industrial process control system, for example, by conferring on it the novel possibilities in terms of adaptivity to a complex and changing environment.

It is also possible that the base data separation module performs a sequential sort, for example: 70% in learning, 20% in generalization, 10% in test, or in another variant, a first sequential sort into two subsets (the first subset comprising the learning and generalization data and the second subset comprising the test data). The data separation module then performs a random sort on the first subset so as to separate out the learning and generalization subsets.

The base data separation module can also perform a sort of the type selection of one (or more) sample(s) according to a law programmed in advance (for example: every N samples) for generation of the learning, generalization and/or test subsets.

It is also possible to prepare the missing, aberrant or exceptional data into one or more groups in a manner such as to regroup them in a same category in order to apply to them a particular treatment (for example: a weighting, a “false alarm” category, etc.).

In one variant, there is calculated for each input variable its explicative power (or discriminatory power) in relation to the phenomenon under study. This process enables, on the one hand, the selection in a list of the preponderant variables and the elimination of the second order variables and, on the other hand, explication of the phenomenon being studied. Preparation of the data can be performed by segmentation algorithms which can, for example, be of the “decision tree” or “machine vector support” type.

There is preferably associated with each state of a “nominal” value (for example the postal code or “APE” code), a table of values translating its significance in relation to the phenomenon under study (for example: the number of inhabitants of the town, income level of the town, average age of the town inhabitants, etc.). It is then possible to code the nominal variables in the form of a table of Boolean or real variables.

In flow model applications, the temporal data (date) are transformed by applying transfer rules stemming from the knowledge of the phenomenon under study. For example, for a financial flow model, when a day is a holiday the associated amounts are transferred according to a profession rule in part over the preceding days and in part over the following days according to weighting coefficients.

It is also possible to treat the flows (for example, financial exchanges) by identifying the periodic payment dates (for example, monthly payment dates) and applying the transfer rules governing each payment date (for example: if the payment date falls on a holiday, transfer the transactions to the following day, etc.).

A post-treatment function (which can be derived from the coefficient λ) allowing calculation of the robustness (or precision) of the model generated on new unlearned data can be applied to the result.

When the database only possesses few elements characteristic of a phenomenon to be modeled, the learning, generalization and forecasting spaces can be not disjoint (for example: use of data belong to the “learning” subset for generating the “generalization” or “forecasting” subsets).

The data prepared can be divided among different uses of the data modeling process of the invention.

The data set is managed in a specific environment ensuring the availability of the information by using, for example, a file system, a database or a specific tool. It is possible to provide simultaneous access to the data to multiple users. For this purpose, one defines a relational structure based on the variables, the phenomena and the models for storing and managing the base data set, the descriptive formulas of the phenomena.

1. Process for modeling digital data from a data sample, comprising an input data acquisition step, an input data preparation step, a step of construction of a model by learning on the treated data, a step of analyzing the performances of the model obtained, a step of exploiting the model obtained, characterized in that the coherence of the classic regression learning process is controlled by the addition to the covariance matrix of a perturbation in the form of a matrix H dependent on a vector of k parameters Λ=(λ₁, λ₂, . . . λₖ) or in the form of the product of a scalar λ times a matrix H, during calculation of the model.

2. Data modeling process according to the principal claim, characterized in that the matrix H verifies the following conditions: H(i, i) is close to 1 for i comprised between 1 and p, H(p+1, p+1) is close to 0 and H(i, j) is close to 0 for i different from j.

3. Data modeling process according to the principal claim, characterized in that the matrix H verifies the following conditions: H(i, i) is close to a for i comprised between 1 and p, H(p+1, p+1) is close to b, H(i, j) is close to c for i different from j and a=b+c.

4. Data modeling process according to claim 3, characterized in that the matrix H verifies the following supplementary conditions: a is close to 1−1/p, b is close to 1, c is close to −1/p, in which p is the number of variables of the model.

5. Data modeling process according to the principal claim, characterized in that the matrix H verifies the following condition: H(p+1, p+1) is different from at least one of the terms H(i, i) for i comprised between 1 and p.

6. Data modeling process according to anyone of the preceding claims, characterized in that one performs a supplementary adjustment step either of the scalar λ or of the vector of parameters Λ(5), with this step being the object of automation, either by acting directly on the parameter(s) or by means of a coding function (exponential or logarithm).

7. Data modeling process according to claim 6, characterized in that the step of adjusting the scalar λ or the vector of the parameters Λ is implemented by the integration of a module for the separation of the learning data into two preferably disjoint subsets: one subset serving as learning base for the modeling process according to the principal claim, and the other serving for adjusting the value of the parameter λ or the vector Λ according to a model validity criterion obtained on the data that did not participate in the learning.

8. Data modeling process according to claim 6 or 7, characterized in that the base data separation step can be implemented by an operator using, for example, an external software program of the spreadsheet or database type, or specific tools.

9. Data modeling process according to anyone of claims 6 to 8, characterized in that the base data separation step performs a purely random sort into two subsets.

10. Data modeling process according to anyone of claims 6 to 8, characterized in that the base data separation step performs a random sort into two subsets, while respecting the representativeness of the input vectors in the two subsets.

11. Data modeling process according to anyone of claims 6 to 8, characterized in that the base data separation module performs a sequential sort.

12. Data modeling process according to anyone of claims 6 to 8, characterized in that the base data separation module performs a first sort into two subsets, with the first subset comprising the learning and generalization data and the second subset comprising the test data.

13. Data modeling process according to any one of claims 6 to 8, characterized in that the base data separation module performs a sort of the type selecting at least one sample according to a law programmed in advance for the generation of learning, generalization and/or test subsets.

14. Data modeling process according to any one of the preceding claims, characterized in that the data are prepared by a statistical normalization of the columns of data.

15. Data modeling process according to anyone of the preceding claims, characterized in that the data are prepared by a reconstitution of the missing data.

16. Data modeling process according to anyone of the preceding claims, characterized in that the data are prepared by detection and possible correction of the aberrant values.

17. Data modeling process according to anyone of the preceding claims, characterized in that the data are prepared by a monovariable or multivariable development applied to all or part of the input.

18. Data modeling process according to any one of the preceding claims, characterized in that the data are prepared by a periodic development of the input.

19. Data modeling process according to any one of the preceding claims, characterized in that the data are prepared by an explicative development of the input of date type.

20. Data modeling process according to any one of the preceding claims, characterized in that the data are prepared by a change in reference point, stemming from a principal component analysis with possible simplification.

21. Data modeling process according to any one of the preceding claims, characterized in that the data are prepared by one or more temporal shifts before or after all or part of the columns containing the temporal variables.

22. Data modeling process according to anyone of the preceding claims, characterized in that an explorer is added to the preparations (6), which is supported on a descriptor of the possible preparations by the user and on an exploration strategy based either on a pure performance criterion in learning or in generalization, or on a compromise between these performances and the capacity of the learning process obtained.

23. Data modeling process according to anyone of the preceding claims, characterized in that there is added to the modeling process an exploitation module (7) generating monovariable or multivariable polynomial formulas descriptive of the phenomenon.

24. Data modeling process according to any one of the preceding claims, characterized in that there is added to the modeling process an exploitation module (7) generating periodic formulas descriptive of the phenomenon.

25. Data modeling process according to anyone of the preceding claims, characterized in that there is added to the modeling process an exploitation module (7) generating descriptive formulas of the phenomenon containing date developments in calendar indicators.

26. Data modeling process according to claim 18, characterized in that the periodic development is a trigonometric development.

27. Data modeling process according to claim 24, characterized in that the periodic formulas descriptive of the phenomenon are of trigonometric base.

28. Data modeling process according to any one of the preceding claims, characterized in that “nominal” type data are prepared in order to reduce the number of distinct states by operating with one or more of the following actions:
calculating the amount of information brought by each step;
regrouping with each other the states homogeneous in relation to the phenomenon under study;
creating a specific state regrouping all of the elementary steps not providing significant information on the phenomenon.

29. Data modeling process according to anyone of the preceding claims, characterized in that the missing, aberrant or exceptional data are regrouped into one or more groups so that specific treatments can be applied to them.

30. Data modeling process according to any one of the preceding claims, characterized in that the nominal variables are coded in the form of a table of Boolean or real variables.

31. Data modeling process according to any one of the preceding claims, characterized in that there is calculated for each input variable its explicative power in relation to the phenomenon under study.

32. Data modeling process according to any one of the preceding claims, characterized in that the data are prepared by segmentation algorithms that can be, for example, of “decision tree” or “machine support vector” type.

33. Data modeling process according to any one of the preceding claims, characterized in that there is associated with each state of a “nominal” variable, a table of values translating its significance in relation to the phenomenon under study.

34. Data modeling process according to anyone of the preceding claims, characterized in that the data are transformed by applying the transfer rules stemming from knowledge of the phenomena under study.

35. Data modeling process according to anyone of the preceding claims, characterized in that the flows are treated by identifying the periodic due dates and applying to them the transfer rules appropriate to each due date.

36. Data modeling process according to any one of the preceding claims, characterized in that the learning, generalization and forecasting spaces can be not disjoint.

37. Data modeling process according to anyone of the preceding claims, characterized in that there is defined a relational structure based on the variables, the phenomena and the models for storing and managing the base data set, the descriptive formulas of the phenomenon,

38. Device for modeling digital data from a data sample, comprising means for acquiring the input data (1), means for preparing the input data (2), means for constructing a model by learning on the processed data (3), means for analyzing the performances of the model obtained (4), means for exploiting the model obtained (7), characterized in that it comprises means for controlling the coherence of the classic regression learning process by the addition to the covariance matrix of a perturbation in the form of a matrix H dependent on a vector of k parameters Λ=(λ₁, λ₂, . . . λₖ) or in the form of the product of a scalar λ times a matrix H, during calculation of the model.
